(19) United States
(12) Patent Application Publication
(10) Pub. No.: US 2024/0303344 A1
(43) Pub. Date: Sep. 12, 2024

(54) METHODS, SYSTEMS, AND COMPUTER READABLE MEDIA FOR BREACH AND ATTACK SIMULATION

(71) Applicant: Keysight Technologies, Inc., Santa Rosa, CA (US)

(72) Inventors: Radu-Emanuel Chiscariu, Bucharest (RO); Andrei-Marian Buzoianu, Buzau (RO); Ebru Resul, Medgidia (RO); Mihaela Badiu, Bucharest (RO)

(21) Appl. No.: 18/119,202

(22) Filed: Mar. 8, 2023

(30) Foreign Application Priority Data
Mar. 8, 2023 (RO) A 2023 00109

(51) Int. Cl. G06F 21/57; G06F 21/53

(52) U.S. Cl. CPC G06F 21/577; G06F 21/53; G06F 2221/034

(57) ABSTRACT

Methods, systems, and computer readable media for breach and attack simulation. An example method includes detonating malware within a sandbox; analyzing one or more impacts of the malware based on detonating the malware within the sandbox; generating, based on analyzing the one or more impacts of the malware, an executable malware emulation file; executing the executable malware emulation file on an endpoint system featuring an installed endpoint detection and response (EDR)-under-test solution; analyzing the performance of the EDR-under-test in response to executing the executable malware emulation file; and reporting one or more test results based on analyzing the performance of the EDR-under-test.

### CROSS-REFERENCE TO RELATED APPLICATIONS

This application claims the priority benefit of Romanian Patent Application No. (to be assigned), filed Mar. 7, 2023, the disclosure of which is incorporated herein by reference in its entirety.

### TECHNICAL FIELD

The subject matter described herein relates to methods, systems, and computer readable media for breach and attack simulation.

### BACKGROUND

Breach and Attack Simulation (BAS) systems are security tools designed to simulate real-world cyber-attacks and security breaches to test the effectiveness of an organization's security measures and identify vulnerabilities. The main purpose of BAS is to provide organizations with a means to proactively identify and remediate security weaknesses before they can be exploited by malicious actors. This is accomplished by simulating distinct types of cyber-attacks, such as phishing, malware infections, and network intrusions, and assessing the organization's ability to detect and respond to these attacks.

BAS systems typically work by using a combination of automated tools and manual techniques to simulate attacks, and they may be integrated with other security tools such as firewalls, intrusion detection systems, and security information and event management (SIEM) systems. The results of a BAS test can provide valuable insight into the strengths and weaknesses of an organization's security posture and help to prioritize remediation efforts. This can help organizations to improve their overall security posture, reduce the risk of a successful cyber-attack, and comply with various industry regulations and standards.

Accordingly, a need exists for methods, systems, and computer readable media for breach and attack simulation.

### SUMMARY

Methods, systems, and computer readable media for breach and attack simulation. An example method includes detonating malware within a sandbox;

analyzing one or more impacts of the malware based on detonating the malware within the sandbox; generating, based on analyzing the one or more impacts of the malware, an executable malware emulation file; executing the executable malware emulation file on an endpoint system executing an endpoint detection and response (EDR)-under-test; analyzing the performance of the EDR-under-test in response to executing the executable malware emulation file; and reporting one or more test results based on analyzing the performance of the EDR-under-test.

The subject matter described herein may be implemented in software in combination with hardware and/or firmware. For example, the subject matter described herein may be implemented in software executed by a processor. In one example implementation, the subject matter described herein may be implemented using a non-transitory computer readable medium having stored therein computer executable instructions that when executed by the processor of a computer control the computer to perform steps. Example computer readable media suitable for implementing the subject matter described herein include non-transitory devices, such as disk memory devices, chip memory devices, programmable logic devices, field-programmable gate arrays, and application specific integrated circuits. In addition, a computer readable medium that implements the subject matter described herein may be located on a single device or computer platform or may be distributed across multiple devices or computer platforms.

### BRIEF DESCRIPTION OF THE DRAWINGS

The subject matter described herein will now be explained with reference to the accompanying drawings of which:

FIG. 1 is a block diagram of an example network environment including a breach and attack simulator, a target system simulator, and a target network.

FIG. 2 is a block diagram illustrating an example kill chain that can be simulated by the breach and attack simulator.

FIG. 3 is a block diagram illustrating a method for building a binary file based on malware behavior for use in the breach and attack simulator.

FIG. 4 is a flow diagram of an example method for breach and attack simulation.

### DETAILED DESCRIPTION

The subject matter described herein includes methods, systems, and computer readable media for breach and attack simulation. An example system can be configured to produce assessments based on malware behavior, which allow customers to test their infrastructure security posture. In some conventional systems, a security assessment includes a list of audits that mimic a specific malware action. They are executed sequentially on the system-under-test. If an assessment contains many audits, then the assessment tends to take a long time to complete.

This document describes a pipeline that takes as input a malware binary and produces an equivalent executable file (e.g., portable executable (PE) file) in terms of IOCs (indicators of compromise) and TTPs (MITRE tactics, techniques, and procedures). With this approach, the system can generate assessments that better resemble a real malware infection, with the added benefit of speeding up the assessment execution time by potentially a large margin.

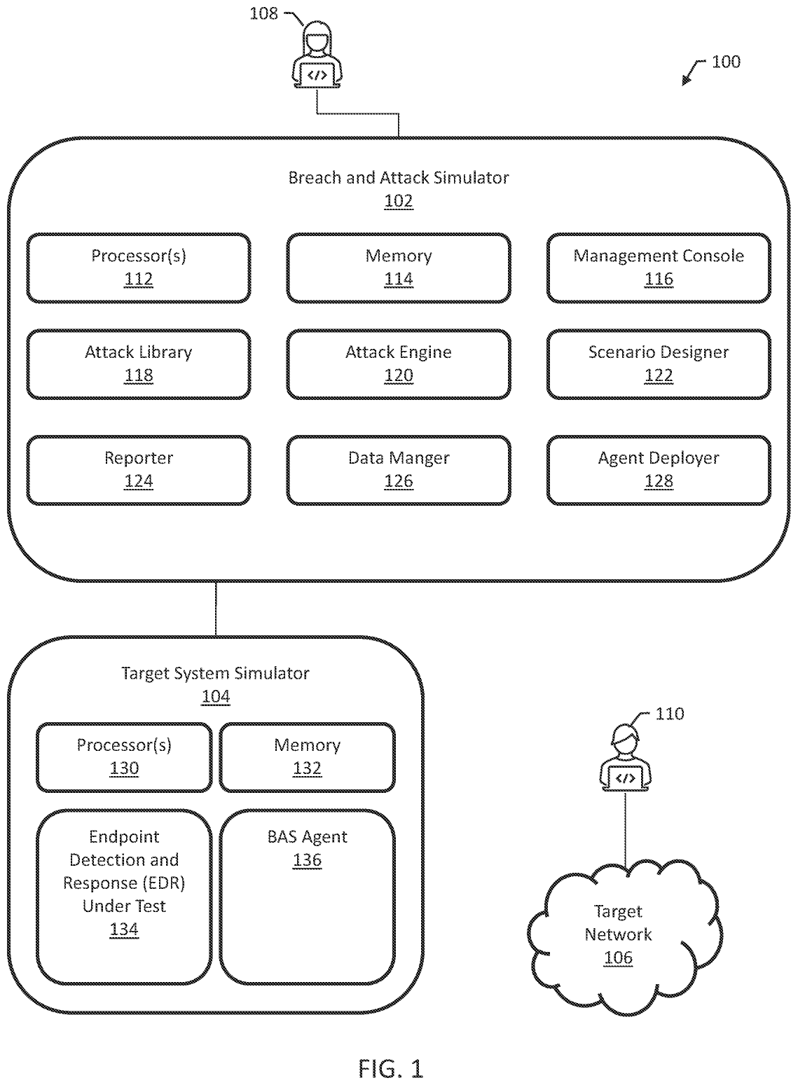

FIG. 1 is a block diagram of an example network environment 100 including a breach and attack simulator 102, a target system simulator 104, and a target network 106. The target network 106 can be, e.g., a network for a business, university, or other organization having many computer systems. A system administrator 108 uses the breach and attack simulator 102 to test the security posture of the network 106 and prevent attacks from an attacker 110.

The breach and attack simulator 102 is a computer system that includes one or more processors 112 and memory 114 storing instructions for the processors 112. The breach and attack simulator 102 includes a management console 116. The management console 116 is the central interface used to manage and configure the breach and attack simulator 102. It allows the system administrator 108 to set up, customize, and execute simulated attacks against the target network 106. The management console 116 may include features such as user management, simulation execution scheduling, and reporting. It provides an overview of the simulated attacks and their outcomes, allowing the system administrator 108 to identify weaknesses and improve the network's security posture.

The breach and attack simulator 102 includes an attack library 118. The attack library 118 is a repository of known attack techniques that can be used to simulate real-world attacks. The library 118 contains information about the tools, tactics, and procedures (TTPs) used by attackers to gain unauthorized access to systems or exfiltrate data. The library 118 may include both publicly available and custom-built attack techniques.

In some examples, the library 118 includes audits and assessments. An audit targets one MITRE technique. Multiple audits bundled together based on certain criteria and executed together form an assessment.

MITRE is a non-profit organization that operates research and development centers sponsored by the U.S (United States). government. One of the key initiatives that MITRE is involved in is the development of the MITRE ATT&CK framework. This framework is a comprehensive knowledge base of adversary tactics, techniques, and procedures (TTPs) that can be used by organizations to understand the behavior of threat actors and develop more effective security strategies.

An example of a MITRE technique is the use of “Spear Phishing” by an attacker to gain access to a target system. Spear phishing is a form of phishing that is targeted at a specific individual or organization and is designed to trick the target into revealing sensitive information, such as login credentials or financial information.

In the context of the MITRE ATT&CK framework, the use of spear phishing is a well-documented TTP that is used by a wide range of threat actors to gain initial access to target systems. By understanding this TTP, organizations can develop more effective defenses against spear phishing attacks, such as educating employees about the dangers of phishing and deploying technical controls to detect and block phishing attempts.

MITRE ATT&CK Endpoint is a component of the larger MITRE ATT&CK framework, which is a globally accessible knowledge base of adversary tactics and techniques based on real-world observations. The MITRE ATT&CK Endpoint specifically focuses on endpoint security and provides a comprehensive understanding of the tactics and techniques used by adversaries to compromise endpoints, such as laptops, desktops, and servers.

The Endpoint component of the MITRE ATT&CK framework provides a detailed and comprehensive understanding of the distinct stages of an attack on endpoints, including initial access, execution, persistence, privilege escalation, defense evasion, credential access, discovery, and lateral movement. This information can be used by security practitioners to better understand the threat landscape and improve their endpoint security strategies.

MITRE ATT&CK Endpoint is based on real-world observations and includes information on distinct types of attacks, such as malware infections, phishing, and PowerShell abuse. The framework provides a common language for describing and communicating about endpoint security threats, making it easier for organizations to share information and collaborate on improving their security posture.

The breach and attack simulator 102 includes an attack engine 120. The attack engine 120 is the software that executes the simulated attacks against the target system 104. It uses the attack library 118 to select and execute attack techniques based on a simulated scenario. The attack engine 120 may include features such as attack customization, attack automation, and attack sequencing.

The breach and attack simulator 102 includes a scenario designer 122. The scenario designer 122 is a tool used to create custom attack scenarios and test the effectiveness of specific defenses. It allows the system administrator 108 to create complex attack scenarios that simulate real-world threats and test the effectiveness of their security controls against these scenarios. The scenario designer 122 may include features such as drag-and-drop attack creation, customizable attack parameters, and simulation scheduling.

The breach and attack simulator 102 includes a reporter 124. The reporter 124 is configured to generate reports on the simulated attacks and the effectiveness of the security defenses. It can provide detailed information on the simulated attacks, including attack vectors, attack outcomes, and the effectiveness of the security controls. The reporting module may include features such as customizable report templates, report scheduling, and report sharing.

The breach and attack simulator 102 includes a data manager 126. The data manager 126 is configured for storing and managing the simulation data, including attack logs and system configurations. It provides a secure and centralized location for storing the results of the simulated attacks, making it easy to analyze the data and generate reports. The data manager 126 may include features such as data backup and recovery, data encryption, and access control.

The breach and attack simulator 102 includes an agent deployer 128. The agent deployer 128 is configured for deploying agents to target systems to collect data and assess the effectiveness of security controls. Agents are lightweight software components installed on target systems to collect data such as system logs, network traffic, and configurations. The agents are used to assess the effectiveness of security controls and identify vulnerabilities in the target systems. The agent deployment process may include features such as agent management, agent configuration, and agent deployment scheduling.

The target system simulator 104 is a computer system configured to simulate one or more of the computer systems in the target network 106. FIG. 1 shows the target system simulator 104 as a separate system from the breach and attack simulator 102; however, in some examples, the two systems are integrated. The target system simulator 104 includes one or more processors 130 and memory 132 storing instructions for the processors 130.

The target system simulator 104 simulates a target system for testing security controls. In the example shown in FIG. 1, the target system simulator 104 is running an agent 134 from the breach and attack simulator and an endpoint detection and response system (EDR) under test 134. The agent 134 from the breach and attack simulator 102 would be used to simulate various attack scenarios, while the EDR under test 134 is configured for detecting and responding to these simulated attacks.

For example, the EDR under test 134 would be configured to monitor the simulated target system for signs of compromise and take action to prevent or mitigate the effects of the attack. The EDR under test 134 might, for example, monitor for suspicious activity such as unusual network traffic, unexpected system behavior, or the execution of known malicious files.

Typically, an EDR-under-test is a security solution designed to detect and respond to security threats on endpoints, such as laptops, desktop computers, and servers. The purpose of testing an EDR system is to evaluate its capabilities, performance, and overall effectiveness. This can involve a variety of activities, such as running security scans, simulating real-world attack scenarios, and evaluating the accuracy and speed of threat detections.

During an EDR evaluation, the EDR-under-test is typically installed on a set of test endpoints and monitored for a period. During this time, security analysts will evaluate the performance of the EDR system and its ability to detect and respond to several types of security threats.

The results of an EDR evaluation can provide valuable insights into the capabilities and limitations of a particular EDR solution and can be used to help organizations make more informed decisions about their security posture. By evaluating an EDR-under-test, organizations can gain a better understanding of how well the solution will perform in their environment and can make more informed decisions about their security investments.

Throughout the simulation, the breach and attack simulator 102 would collect data on the simulated attacks and their outcomes, providing the system administrator 108 with insights into the effectiveness of the security controls on the target network 106. The simulation results would be analyzed and used to identify weaknesses in the organization's security defenses, improve security policies and procedures, and enhance the overall security posture of the organization.

In some examples, the breach and attack simulator 102 is configured to continuously measure and optimize security risk for the target network 106. The breach and attack simulator 102 can provide one or more of the following functions:
Simulate the entire kill chain using real-world malware and techniques
Accurately measure SIEM rules and detection capabilities
Quickly fix misconfigurations

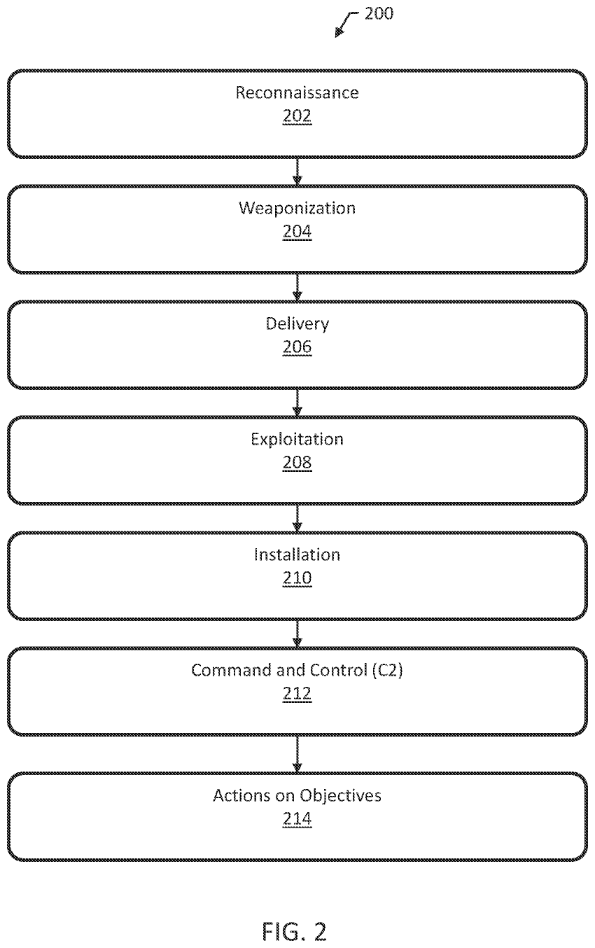

FIG. 2 is a block diagram illustrating an example adversary attack kill chain 200 that can be simulated by the breach and attack simulator 102. In the context of cybersecurity and malware, a kill chain is a framework used to describe the distinct stages of a cyberattack, from the initial reconnaissance to the final exfiltration of data. The kill chain 200 shown in FIG. 2 includes reconnaissance 202, weaponization 204, delivery 206, exploitation 208, installation 210, command and control (C2) 212, and actions on objectives 214.

During reconnaissance 202, the attacker gathers information about the target, such as its network topology, vulnerabilities, and potential targets. During weaponization 204, the attacker creates a malicious payload, such as a virus, Trojan, or ransomware, and packages it in a way that allows it to evade detection by security software. During delivery 206, the attacker delivers the payload to the target, usually through a phishing email, a compromised website, or a network exploit.

During exploitation 208, the payload exploits a vulnerability in the target's system or network, allowing the attacker to gain access and escalate privileges. During installation 210, the payload installs itself on the target system, often using techniques to evade detection by security software. During command and control 212, the payload establishes a connection to a remote server controlled by the attacker, allowing the attacker to remotely control the target system and exfiltrate data. During actions on objectives 214, the attacker carries out their ultimate objective, which could include stealing sensitive data, encrypting data for ransom, or disrupting the target's operations.

In some conventional systems, an endpoint assessment is created by first determining the behavior of the malware and then selecting audits that map to the malware behavior. If new behavior is encountered, then new audits need to be developed and then added to the assessment.

This kind of assessment, however, may be undesirable in certain cases. For example, the time of execution may become exceedingly long for certain types of malware. That situation occurs when a malware uses many native API (Application Programming Interface) calls, which causes the resulting assessment to take a long time to complete, due to context switching between many audits. Another issue is that the kill chain assessment in a conventional system may lack realism compared to the malware-to-be-emulated. As the audits composing the assessment are independent processes, the assessment in some conventional systems amounts to multiple processes run sequentially. This design of a kill chain assessment associated to a malware lacks realism, as a real malware is usually executed as a single process that spawns subsequent processes and threads.

The breach and attack simulator 102 of FIG. 1 can be configured to use a pipeline that takes as input a malware binary and produces an equivalent executable file (e.g., portable executable (PE) file) in terms of IOCs (indicators of compromise) and TTPs (MITRE tactics, techniques, and procedures). With this approach, the system can generate assessments that better resemble a real malware infection, with the added benefit of speeding up the assessment execution time by potentially a large margin.

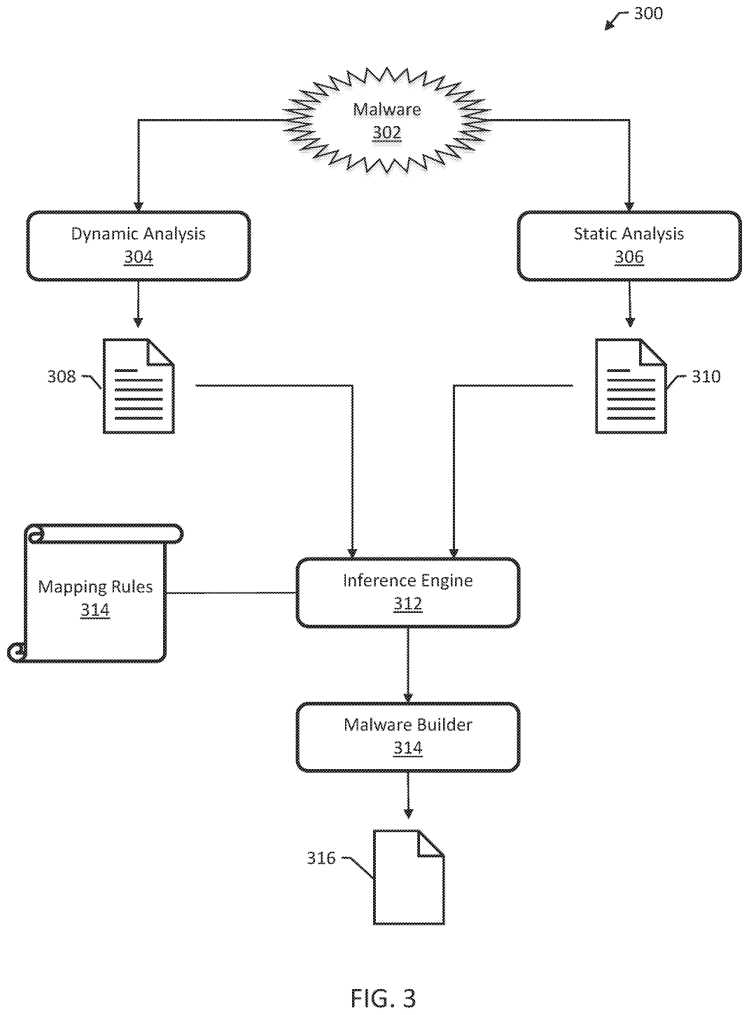

FIG. 3 is a block diagram illustrating a method 300 for building a binary file based on malware behavior for use in the breach and attack simulator 102. The method 300 begins with identifying malware 302 for analysis. The malware 302 can be identified, e.g., by a software engineer or by an automated computer process. The malware 302 can be identified from news or security blogs that report on new malware outbreaks or discoveries, or from antivirus databases that contain signatures of known malware and are updated regularly. The malware 302 can comprise one or more executable files or other suitable files for carrying out malicious computer attacks.

The method 300 includes performing dynamic analysis 304 and static analysis 306 of the malware 302. Performing dynamic analysis 304 can include setting a controlled environment such as a sandbox, which is a virtual machine or a system that isolates the malware from the rest of the network, and then executing the malware 302 in the sandbox and interacting with it to activate its malicious functionality. For example, performing dynamic analysis 304 can include running one or more tools to capture and analyze the malware's behavior, such as network traffic, registry changes, running processes, file operations, and the like.

Performing dynamic analysis 304 includes generating a dynamic analysis report 308 by recording the actions and changes caused by the malware 302, such as domains contacted, keys added or deleted, processes created or terminated, files encrypted or deleted, and so on. In some examples, the report 308 includes one or more of the following:
The network traffic generated by the malware 302, such as domains contacted, ports used, or protocols followed.
The registry changes by made by the malware 302, such as adding or deleting keys or values.
The running processes created or terminated by the malware 302, such as services, drivers, or modules.
The intent of the malware 302, such as stealing data, encrypting files, or opening backdoors.

Performing static analysis 306 includes analyzing the malware 302 without executing it. This is achieved by examining the code or binary of the malware file, without running it. Static analysis provides a deeper understanding of the malware's structure and functionality and can be used to identify specific features or functions that may be malicious. Additionally, it can be used to identify the code responsible for specific behaviors or functions of the malware.

Performing static analysis 306 includes generating a static analysis report 310 that summarizes the findings of the static analysis 306. The report 310 can include one or more of the following:
The file name, size, type, hash, and digital signature of the malware binary
The strings, imports, exports, resources, and sections extracted from the binary
The possible functionality, purpose, behavior, and origin of the malware based on code analysis

The reports 308 and 310 are provided to an inference engine 312. The inference engine 312 is trained using mapping rules 314, which can include signatures for static and dynamic behavior of malware. The inference engine 312 identifies matched methods from a library of malicious methods and identifies those methods to a malware builder 314.

In some examples, in operation, the inference engine 312 extracts relevant features from the reports 308 and 310, such as function calls, API calls, system calls, or other behaviors exhibited by the malware 302. The extracted features can be preprocessed to transform them into a suitable format for machine learning models or rule-based matching algorithms. This could involve normalization, tokenization, or other methods.

The inference engine 312 leverages malware behavior-related rules to match the extracted malware features against calls to a library that implements known malicious methods. This library could be curated manually or generated using automated techniques that extract routines/functions from the malware itself. The inference engine 312 can use machine learning models, such as neural networks or decision trees, to match the extracted features against the malicious method library. This would involve training the model, e.g., on a large dataset of known malware and associated malicious methods.

Alternatively, the inference engine 312 can use a rule-based matching approach to identify patterns in the extracted features that match known malicious methods. This could involve regular expressions, pattern matching, or other techniques. The inference engine 312 can output the matched methods from the malicious method library that are most likely to be present in the malware 302 or that are most likely to be critical for EDR testing from the malware 302.

The malware builder 314 is configured to produce an emulation file 316. The emulation file 316 is a binary file that, upon execution, produces an execution chain similar or identical to the malware itself. For instance, the emulation file 316 can be equivalent to the malware 302 in terms of IOCs and TTPs.

IOCs, or Indicators of Compromise, are specific pieces of evidence that suggest that a system or network has been compromised by malware. Examples of IOCs include specific file names or hashes, IP (Internet Protocol) addresses, domain names, or registry keys. IOCs are used to identify instances of malware on a system and can be used as a basis for developing detection and response strategies.

TTPs, or Tactics, Techniques, and Procedures, are the methods and strategies used by adversaries to achieve their objectives. TTPs provide a comprehensive understanding of how malware operates, including the methods used to gain initial access, persist on a system, evade detection, and carry out malicious activities.

For realism, the resulting emulation file 316 is the same type of file as the malware itself 302. Usually, the malware presents itself as a PE file. PE files are binary files that contain executable code and metadata that describe how the code should be loaded and executed by the Windows operating system. This metadata includes information such as the file header, import and export tables, resources, and sections that hold the code and data.

When a PE file is loaded by the operating system, it is mapped into memory and the code and data in the file are executed. PE files can be compiled from source code in a variety of programming languages, including C, C++, and C#.

The emulation file 316 can be used by the breach and attack simulator 102 of FIG. 1. For example, the scenario designer 122 can create a test scenario where the emulation file 316 gets deployed on the target system simulator 104 using the agent 136. As a result, the breach and attack simulator 102 produces an endpoint kill-chain assessment emulating the behavior of malware 302 that does not initiate traffic to the malicious domain used by the actual malware, but otherwise features the same objectives using the BAS infrastructure.

The emulation file 316 can allow the breach and attack simulator 102 to respect the process tree, i.e., with respect to the malware 302, e.g., regarding new child processes or suspended processes for process injection. Process injection is a technique used by malware to hide its presence on a compromised system, evade detection, and execute malicious code within a legitimate process. The emulation file 316 can be configured to emulate process injection as detected in the malware 302.

In some cases of process injection, the malware selects a target process that is already running on the compromised system. The selected process has the necessary privileges and capabilities to perform the malicious activity that the malware intends to carry out.

The malware then allocates memory space within the target process' address space. This space will be used to hold the malicious code that the malware wants to execute within the legitimate process. Next, the malware injects its malicious code into the allocated memory space within the target process. This is typically done by writing the malicious code to the allocated memory space, overwriting some existing code in the process.

The malware then uses hooking techniques to hijack the execution flow of the legitimate process and redirect it to the injected malicious code. This can be achieved using various techniques such as modifying the function pointers or DLL (Dynamic Link Library) files loaded into the target process. Once the malicious code is injected and hooked, the malware gains control over the target process and can execute its malicious activities without being detected. This can include stealing data, spreading to other systems, or carrying out other malicious actions. To evade detection and further hide its presence, the malware may take steps to cover its tracks by restoring any overwritten code or cleaning up any artifacts left behind by the injection process.

In some examples, the method 300 includes obfuscating the emulation file 316. For example, the breach and attack system 102 of FIG. 1 can get a binary file with a new digital signature each time an assessment is run. Obfuscation can include removing string literals or other references within the emulation file 316 that enable reverse engineering.

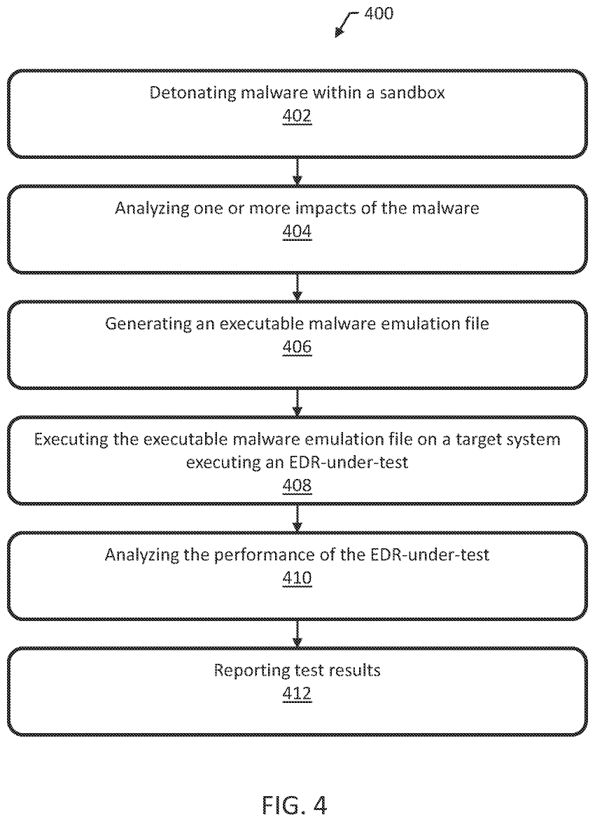

FIG. 4 is a flow diagram of an example method 400 for breach and attack simulation. The method 400 can be performed, for example, by the breach and attack simulator 102 of FIG. 1.

The method 400 includes detonating malware within a sandbox (402). The method 400 includes analyzing one or more impacts of the malware based on detonating the malware within the sandbox (404). Analyzing one or more impacts of the malware based on detonating the malware within the sandbox can include performing both dynamic analysis and static analysis of the malware. Analyzing the impacts of the malware can include extracting functions and routines from the malware itself to improve the realism of the emulation.

The method 400 includes generating, based on analyzing the one or more impacts of the malware, an executable malware emulation file (406). Generating the executable malware emulation file can include generating the executable malware emulation file such that, upon execution, the executable malware emulation file causes a plurality of steps of a kill chain for the malware. The executable malware emulation file can include one or more of the extracted functions and routines from the malware itself.

The executable malware emulation file can be configured such that, upon execution, the executable malware emulation file causes execution of a process tree for the malware, including at least one instance of process injection. The executable malware emulation file can have a same file type as the malware, e.g., dynamic linked library (DLL), portable executable (PE), or document with embedded script.

In some examples, generating the executable malware emulation file comprises supplying a dynamic analysis report or a static analysis report or both to an inference engine trained on a plurality of signatures for static and/or dynamic behavior of training malware.

The method 400 includes executing the executable malware emulation file on an endpoint system executing an endpoint detection and response (EDR)-under-test (408). For example, executing the executable malware emulation file on an endpoint system executing an endpoint detection and response (EDR)-under-test can include executing the executable malware emulation file on a virtual machine configured for a target test network.

The method 400 includes analyzing the performance of the EDR-under-test in response to executing the executable malware emulation file (410). The method 400 includes reporting one or more test results based on analyzing the performance of the EDR-under-test (412). Reporting one or more test results based on analyzing the performance of the EDR-under-test can include reporting a success or a failure of the EDR-under-test to detect and/or respond to the malware. In some examples, reporting includes generating an endpoint assessment for malware behavior emulation such that, upon execution, the assessment results are presented as separate attack stages, even though the malware emulation runs as a single process.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for breach and attack simulation, the method comprising:
detonating malware within a sandbox;
analyzing one or more impacts of the malware based on detonating the malware within the sandbox;
generating, based on analyzing the one or more impacts of the malware, an executable malware emulation file;
executing the malware emulation file on an endpoint system featuring an endpoint detection and response (EDR)-under-test;
analyzing the performance of the EDR-under-test in response to executing the malware emulation file; and
reporting one or more test results based on analyzing the performance of the EDR-under-test.

2. The method of claim 1, wherein analyzing one or more impacts of the malware based on detonating the malware within the sandbox comprises performing both dynamic analysis and static analysis of the malware.

3. The method of claim 1, wherein generating the executable malware emulation file comprises generating the executable malware emulation file such that, upon execution, the executable malware emulation file causes a plurality of steps of a kill chain for the malware.

4. The method of claim 1, wherein generating the executable malware emulation file such that, upon execution, the executable malware emulation file causes similar execution as the malware itself.

5. The method of claim 4, wherein causing similar execution as the malware itself includes leveraging at least one instance of process injection technique.

6. The method of claim 1, wherein generating the executable malware emulation file comprises generating the executable malware emulation file to have a same file type as the malware.

7. The method of claim 6, wherein the file type is one of: dynamic linked library (DLL), portable executable (PE), or document with embedded script.

8. The method of claim 1, wherein generating the executable malware emulation file comprises supplying a dynamic analysis report or a static analysis report or both to an inference engine that is using one or more rules to extract malware behavior.

9. The method of claim 1, wherein reporting one or more test results based on analyzing the performance of the EDR-under-test comprises reporting a success or a failure of the EDR-under-test to detect and/or respond to the malware.

10. The method of claim 1, wherein executing the executable malware emulation file on an endpoint system executing an endpoint detection and response (EDR)-under-test comprises executing the executable malware emulation file on a virtual machine configured for a target test network.

11. A system for breach and attack simulation, the system comprising:
one or more processors and memory storing executable instructions for the one or more processors;
a breach and attack simulator implemented on the one or more processors and configured for:
detonating malware within a sandbox;
analyzing one or more impacts of the malware based on detonating the malware within the sandbox;
generating, based on analyzing the one or more impacts of the malware, an executable malware emulation file;
executing the executable malware emulation file on an endpoint system executing an endpoint detection and response (EDR)-under-test;
analyzing the performance of the EDR-under-test in response to executing the executable malware emulation file; and
reporting one or more test results based on analyzing the performance of the EDR-under-test.

12. The system of claim 11, wherein analyzing one or more impacts of the malware based on detonating the malware within the sandbox comprises performing both dynamic analysis and static analysis of the malware.

13. The system of claim 11, wherein generating the executable malware emulation file comprises generating the executable malware emulation file such that, upon execution, the executable malware emulation file causes a plurality of steps of a kill chain for the malware.

14. The system of claim 11, wherein generating the executable malware emulation file comprises generating the executable malware emulation file such that, upon execution, the executable malware emulation file causes execution of a process tree for the malware.

15. The system of claim 14, wherein execution of the process tree includes at least one instance of process injection.

16. The system of claim 11, wherein generating the executable malware emulation file comprises generating the executable malware emulation file to have a same file type as the malware.

17. The system of claim 16, wherein the file type is one of: dynamic linked library (DLL), portable executable (PE), or document with embedded script.

18. The system of claim 11, wherein generating the executable malware emulation file comprises supplying a dynamic analysis report or a static analysis report or both to an inference engine that maps malicious behavior to a library of malicious behavior designed to stress-test EDR detection capabilities.

19. The system of claim 11, wherein reporting one or more test results based on analyzing the performance of the EDR-under-test comprises reporting a success or a failure of the EDR-under-test to detect and/or respond to the malware.

20. The system of claim 11, wherein testing an endpoint detection and response (EDR) solution comprises executing the resulting malware emulation file on a virtual machine configured for a target test network, featuring an installed EDR-under-test.
